(19) United States
(12) Patent Application Publication
(10) Pub. No.: US 2017/0234104 A1
(43) Pub. Date: Aug. 17, 2017

(54) METHODS FOR WELL TREATMENT

(71) Applicant: Schlumberger Technology Corporation, Sugar Land, TX (US)

(72) Inventor: Simon Gareth James, Clamart (FR)

(21) Appl. No.: 15/501,078

(22) PCT Filed: Aug. 13, 2015
(86) PCT No.: PCT/EP2015/068712

§ 371 Date: Feb. 1, 2017

(30) Foreign Application Priority Data
Aug. 1, 2014 (EP) 14290227.9

(51) Int. Cl. E21B 33/138; C09K 8/42; C04B 26/14; E21B 37/00; C04B 14/04; C04B 18/14; E21B 47/00; C09K 8/52; C04B 26/10

(52) U.S. Cl. CPC E21B 33/138; C09K 8/52; C09K 8/428; C04B 26/14; C04B 26/105; C04B 14/04; C04B 18/146; C04B 14/043; E21B 47/0006; E21B 37/00; E21B 29/06

(57) ABSTRACT

Methods for treating and restoring zonal isolation in a subterranean well involve the use of a well treatment tool that may drill one or more holes in casing and inject a treatment fluid that may seal cracks or fissures in the cement sheath behind the casing. Microannuli may also be sealed. The treatment fluids may be solids free or in the form of suspensions containing solids having a particle size between 1 nm and 100 nm.

### BACKGROUND

The statements in this section merely provide background information related to the present disclosure and may not constitute prior art.

This disclosure relates to techniques for treating wells, in particular for the treatment of zonal isolation problems in wells such as oil or gas wells.

Primary cementing operations in oil and gas wells are performed to support one or more casing strings and to provide hydraulic isolation between the formations penetrated by the well. After primary cementing, various faults may develop in the cement sheath between the casing and the formation (or between two casing strings). These faults include unwanted fluid communication (or leaks) through the annulus behind the casing due to channels in the cement sheath, a microannulus behind the casing, debonding between the cement sheath and the formation wall, channels formed in the cement sheath due to annular fluid migration during the setting process, and fractures in the cement sheath arising from temperature or pressure fluctuations or mechanical disturbances during well intervention procedures. These faults may allow various consequences, such as fluid flow between regions of the well, for example water entering the production stream, gas being produced to surface outside the casing, contamination of aquifers, etc.

Operations to repair faults in the cement sheath or surrounding structures include remedial cementing. In conventional repair techniques, the faults may be located by pressure testing or wireline logging. Once the fault is located, the casing may be perforated to provide fluid communication between the inside and the outside of the casing. Perforating equipment and tools may then removed from the well and may be replaced by drill pipe or tubing. The drill pipe or tubing may be lowered into the well to a depth slightly below the area to fill. Cement treatment fluid may be placed in the casing in front of the zone to repair. Pressure may then be applied to squeeze it into the leak path via the perforations. Finally, the well may be cleaned up to remove excess cement treatment fluid. This may be done by reverse circulating into the drill pipe or tubing. In some applications, packers and/or bridge plugs may be used to confine the squeeze pressure to a section of the well near the repair zone.

A number of limitations of this process exist, including: poor positioning of the treatment tools and cement, lack of control of the perforation process and a generally slow procedure. These limitations may lead to loss of isolation between the formation and the annulus and well interior, despite the apparent repair, due to leakage or fracturing. Problems may also occur during the execution of the job, such as stuck pipe, plugging of the well or leaving dirty casing after the job. The process may be inefficient if multiple zones are to be repaired.

The thickness of annulus to be filled is often quite narrow and its theoretical volume is extremely small (for a 100 micron gap behind a 7-in. (17.8-cm) casing, the volume is approximately 20 cm³ per meter of annulus). Cement treatment fluid may not be able to flow easily through this annulus. Under these circumstances, 2-4 in. (5-10 cm) may be vertically filled before the required pumping pressure reaches a level at which the pressure in the annulus may generate fractures in the cement sheath and the rock around the well. In such a case, the treatment fluid may flow towards the formation rather than into the cement fault. Thanks to this fracture, the new treatment fluid may pressurize the initial cement sheet against the casing, temporarily closing the micro-annulus without effecting full repair.

Certain types of damage may remain after such repair jobs.

The volume of treatment fluid required to fill a channel is typically small, for example, 1.2 L/m for a 5-cm wide, 2.5-cm thick channel. 20 to 50 BBL may be used, most of which may be circulated back to the surface after the injection.

Gas channels formed during cement setting may be quite small. They may be found at the formation/cement interface or on the high side of the well-bore for an inclined well. Due to their size and position in the cement sheath, they may not be detectable by most existing wireline acoustic tools. The lack of isolation generated by these paths may be conducive for gas flow.

Current squeeze techniques may work for plugging existing perforations that produce unwanted fluids (e.g., water or gas). Where an intermediate section of perforations need to be shut-off, packers and bridge plugs may be used to limit the interval to squeeze. This may be time consuming, especially if multiple zones need to be plugged.

In various well conditions, it may be required to ensure top quality isolation behind the casing over a certain zone, for example at a casing shoe of an intermediate casing, when it is expected to encounter high formation pressure during the drilling of the subsequent section. Another application may be to ensure top quality isolation between two formations where isolation is highly desirable, for example, isolation across a cap rock of a high-pressure reservoir situated below a depleted reservoir. With existing techniques, this localized high quality cement may be difficult to achieve, such that the cement has to be extended over a long length of the annulus to achieve the desired seal. This may generate problems (such as increase hydrostatic pressure during placement with a high risk of fracture). Another common situation may be to ensure good quality of the cement near a liner hanger.

### SUMMARY

The present disclosure proposes methods that address some or all of the problems discussed above.

In an aspect, embodiments relate to methods for a subterranean well having a borehole wall, at least one tubular body and at least one cement sheath. In the well, a tool is positioned adjacent to a region to be treated. The tool is locked in place with a clamping system. The tool may be oriented azimuthally with a positioning system. Using a pumping system, a treatment fluid is pumped from a reservoir in the tool to the region of the cement sheath to be treated. The method further comprises drilling a hole into the tubular body prior to pumping treatment fluid. The fluid is solids free or a suspension containing solids having a particle size between 1 nm and 100 nm.

In a further aspect, embodiments relate to methods for restoring zonal isolation in a subterranean well having a borehole wall, at least one tubular body and at least one cement sheath. In the well, a tool is positioned adjacent to a region to be treated. The tool is locked in place with a clamping system. The tool may be oriented azimuthally with a positioning system. Using a pumping system, a treatment fluid is pumped from a reservoir in the tool to the region of the cement sheath to be treated. The method further comprises drilling a hole into the tubular body prior to pumping treatment fluid. The fluid is solids free or a suspension containing solids having a particle size between 1 nm and 100 nm.

### BRIEF DESCRIPTION OF THE DRAWINGS

FIG. 1 shows one embodiment of a tool relating to the disclosure.

FIG. 2 shows a schematic view of a reservoir and pump section of a tool.

FIG. 3 shows a mixing section.

FIG. 4 shows an alternative mixing section.

FIG. 5 shows a dilution system.

FIG. 6 shows a tool in operation with circulation.

FIG. 7 shows a further embodiment of a tool with circulation.

FIGS. 8a and 8b show the pattern of treatment fluid placement behind multiple injection parts as an isolation ring through a specific depth.

### DETAILED DESCRIPTION

At the outset, it should be noted that in the development of any such actual embodiment, numerous implementation-specific decisions may be made to achieve the developer's, specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that concentrations within the range, including the end points, is to be considered as having been stated. For example, “a range of from 1 to 10” is to be read as indicating the numbers along the continuum between about 1 and about 10. Thus, even if specific data points within the range, or even no data points within the range, are explicitly identified or refer to a few specific, it is to be understood that Applicants appreciate and understand that the data points within the range are to be considered to have been specified, and that Applicants possessed knowledge of the entire range and all points within the range.

In an aspect, embodiments relate to methods for a subterranean well having a borehole wall, at least one tubular body and at least one cement sheath. In the well, a tool is positioned adjacent to a region to be treated. The tool is locked in place with a clamping system. The tool is oriented azimuthally with a positioning system. Using a pumping system, a treatment fluid is pumped from a reservoir in the tool to the region of the cement sheath to be treated. The method further comprises drilling a hole into the tubular body prior to pumping treatment fluid. The fluid is solids free or a suspension containing solids having a particle size between 1 nm and 100 nm.

In a further aspect, embodiments relate to methods for restoring zonal isolation in a subterranean well having a borehole wall, at least one tubular body and at least one cement sheath. In the well, a tool is positioned adjacent to a region to be treated. The tool is locked in place with a clamping system. The tool is oriented azimuthally with a positioning system. Using a pumping system, a treatment fluid is pumped from a reservoir in the tool to the region of the cement sheath to be treated. The method further comprises drilling a hole into the tubular body prior to pumping treatment fluid. The fluid is solids free or a suspension containing solids having a particle size between 1 nm and 100 nm.

For both aspects, an operator may perform the methods by using a well treatment tool that comprises a tool body, a clamping system for locating the tool body in the well, a positioning system for orienting the tool body in the well axially and azimuthally, a reservoir system comprising at least one fluid reservoir in the tool body, and a pumping system for pumping fluid from the reservoir to a region of the well to be treated.

The tool can also include a drilling device for drilling into the wall of the well and a plugging device for plugging the hole drilled by the drilling device.

The tool can also include a pad having a port for application against the wall of the well to apply the fluid to the region to be treated. The pad may comprise a packer surrounding the port to isolate the port from other fluids in the borehole when the pad is applied to the wall of the well.

The drilling device and the pad can be provided at separate locations on the tool body, separated axially or azimuthally on the tool body. The drilling device and the pad can also be at substantially the same location on the tool body.

The reservoir system may comprise multiple treatment-fluid reservoirs and the pumping system may include valves allowing selective pumping of fluids from separate reservoirs. A reservoir may be used for a pre-flush fluid to verify injectivity before a treatment.

A mixing system may be included for mixing fluids from the reservoirs. The mixing system may comprise a mixing chamber having a roller system located therein for mixing fluids introduced into the chamber, or a valve system allowing fluids to be pumped back and forth between two reservoirs.

In certain cases, it may be desirable to include a dilution system including a first port near to the tool body, a second port remote from the tool body, a channel connecting the ports and a pump in the channel for pumping well fluids from the well near the second port to the well near the first port.

Sensors may be included for locating faults in a cement sheath surrounding the well and for monitoring the flow of treatment fluid, for example to detect the presence of treatment fluid in the well.

For both aspects, the treatment fluid may comprise a solids free resin. The resin may comprise an epoxy resin or a furan resin or both.

For both aspects, the treatment fluid may comprise a silica-particle suspension. The silica particles may comprise colloidal silica or fumed silica or a combination thereof.

For both aspects, the treatment fluid may comprise an alkali-metal silicate and an inorganic calcium containing compound. The alkali metal silicate may comprise sodium metasilicate, sodium polysilicate, potassium silicate, lithium silicate, rubidium silicate or cesium silicate or a combination thereof. The alkali metal silicate concentration in the treatment fluid may be between a solid:water mass ratio of 10:90 and 30:70. The inorganic calcium containing compound may comprise calcium oxide or calcium hydroxide.

For both aspects, the treatment fluid may comprise an alkali swellable latex. The alkali-swellable latex may comprise homopolymers of methacrylic acid, copolymers of methacrylic acid, copolymers of methacrylate esters or maleic acid or combinations thereof.

For both aspects, the treatment fluid may comprise at least one salt capable of reacting with a set cement to form a solid phase comprising a precipitate or an expanded phase of the cement. Suitable salts may include one or more alkali metal silicates, magnesium chloride, iron chlorides or other iron salts, aluminum chloride, alkali metal aluminates, magnesium phosphate, potassium phosphate, sodium sulfate, sodium carbonate, sodium phosphate or sodium fluoride or combinations thereof. The salts may be present at a solid:water ratio between 3:97 and 30:70. The treatment fluid may comprise iron (III) chloride. The iron (III) chloride may be present at a solid:water mass ratio between 10:90 and 30:70, or at a mass ratio of 15:85. Such treatment fluids may be operationally advantageous in that they have no intrinsic ability to set. Setting may occur when the salts commingle with set cement.

An advantage of the chemical systems described above may include their ability to penetrate and seal very small cracks and fissures in the cement sheath, for example smaller than 1 micrometer. Conventional squeeze cementing slurries may contain larger particles that would block such small openings.

Furthermore, like the saline fluids described earlier, treatment fluids whose compositions comprise silica particles may have a sealing ability that is confined to times and locations where needed. Such suspensions have no intrinsic ability to set. When the silica particles contact the cement sheath—a source of calcium hydroxide—a pozzolanic reaction may ensue resulting in the formation of calcium silicate hydrate, thereby sealing the crack.

For both aspects, the methods may further comprise sealing the hole after pumping.

For both aspects, the methods may further comprise drilling at least two separated holes in the tubular body and circulating treatment fluid from one hole to the other. A cleaning fluid may be pumped through the tool after the treatment fluid has been pumped. The holes can be azimuthally separated, or axially separated. The pumping may be controlled by sensing treatment fluids exiting from the other hole and controlling pumping accordingly.

For both aspects, the methods may further comprise repeating the positioning, locking, orienting and pumping at different locations in the well.

Where the region of the well to be treated is a fault in a cement sheath surrounding the well, the method may further comprise measuring the size, shape and type of fault prior to treatment. The measurement can be repeated after the treatment and the measurement repeated until a satisfactory result is achieved.

The tool may be run in the well in association with a conventional logging tool to determine the proper location of the operation. For a remedial cement job, an imaging acoustic logging tool capable of locating cement faults behind the casing may be used. Other techniques may be used, including azimuthal density and a noise tool for leak detection behind the casing. For intervention in a lateral hole junction, an imaging tool may also be used. For placing a cement isolation ring behind a tubular, a tool to log natural gamma-ray or a CCL (Casing Collar Locator) may be used.

The defect may be detected in the previous run of a locating tool, but it may be advantageous to combine the logging device with the remedial device, leading to time savings, accurate placement of the remedial process, and re-evaluation of the cement sheath after the remedial job.

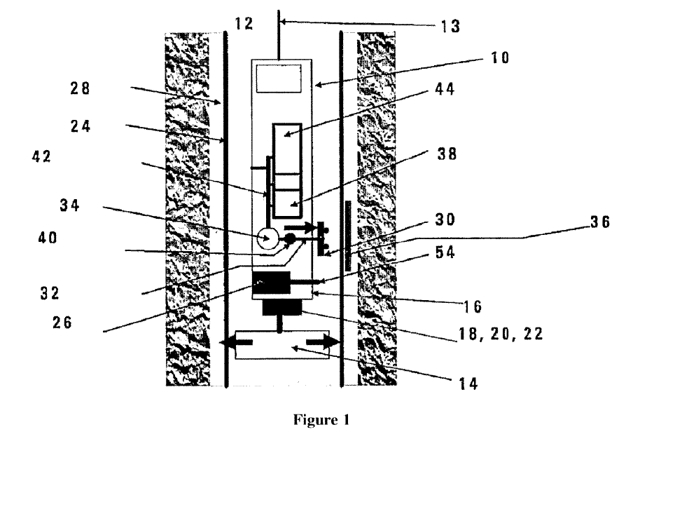

Referring to FIG. 1, when the tool 10 is suspended at the proper location in the well 12 by means of a wireline cable 13, a clamping system 14 locks the tool 10 in the wellbore by a slips system or the extension of radial clamps. The tool then positions its working head 16 at the proper location by means of an integrated positioning mechanism 18 comprising an orienting swivel 20, and a sliding system 22 for axial displacement. These two movements may be performed at high accuracy. One implementation of this comprises a “no-slippage” crawling tractor and an orienting sub. The tractor locks the system in place in a static position, but may also make small controlled axial displacements. The orienting sub performs the azimuthal orientation.

After the proper positioning of the working head 16, the following steps ensure communication with the outside of the tubular body 24 in the well. A hole is drilled through the tubular body (casing) 24 by a drilling system 26 that rotates a drill bit while applying a radial displacement (and force). The drill bit may be driven through the thickness of the initial well annulus behind the casing 24 to ensure the proper communication with the annulus. In the case of repairing a casing micro-annulus, this extension of the drilled hole into the cement sheath 28 may normally be limited to a minimum. For such drilling operations, a device similar to the Schlumberger Cased-Hole Dynamic Tester (CHDT) drilling system may be used.

A sealing pad 30 with a central injection port 32 may then be applied by the tool 10 against the casing 24. The injection port 32 may be aligned with the drilled hole in the casing 24. The injection port 32 may be concentric with the drilling system 26. With such an arrangement, the tool 10 may remain at the same location during the functions. Or, the drilling system 26 may be separated from the sealing pad 30 and the injection port 32. In this case, the tool 10 may move to position each active element in front of the desired location when needed. The displacement, may be performed via either the linear 22 or the azimuthal 18 displacement system without unclamping the locking system 14.

A tool with two different active sections (one for drilling, one for sealing and pumping) may have the advantage of cleaning and maintenance, as either aggressive fluids or hardening fluids may be pumped through the injection port.

After the pad application, the tool 10 may activate its internal pump 34 to circulate and pressurize fluid in the defective area 36 behind the casing 24. This may allow the verification of the injectivity behind the casing which favors successful sealant placement. The fluid used for this injection test may be pumped either from the main wellbore 12 or from a reservoir 38 inside the tool. The injectivity may be monitored by means of a pressure transducer and flow measurement device 40.

When the injectivity has been proven, clean-up of the fluid in the volume to inject may be performed by pumping adequate fluid at a proper flow rate. For the simplest application, the clean-up fluid may be taken from the main wellbore 12 via an intake manifold 42, with the appropriate valve in an open position. However, the clean-up fluid may be taken from the reservoir 38. This fluid may be an appropriate chemical composition to achieve the clean-up, including water, a solvent or an acid.

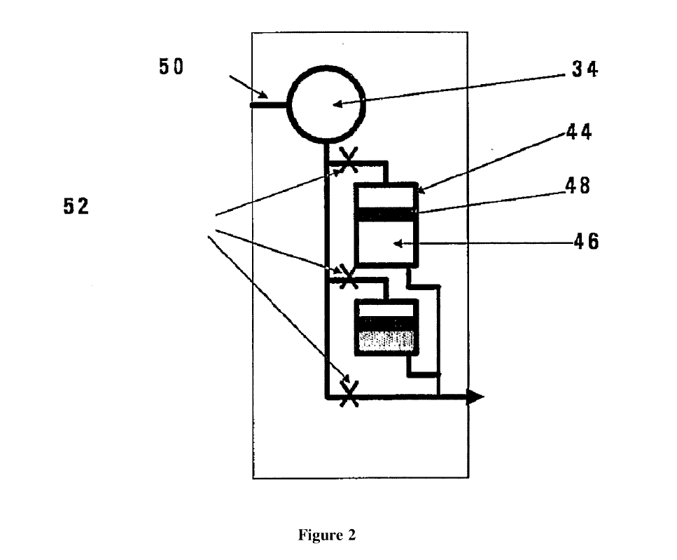

When the clean-up of the defective area 36 is completed, a treatment fluid may be pumped in the volume to inject behind the casing 24. The treatment fluid may be pumped from a reservoir 44 inside the tool 10 through the port 32 of the sealing pad 30 into the drilled hole of the casing 24. The injection parameters such as pressure and flow rate may be monitored. The pumping effect of the treatment fluid 46 may be achieved by pushing a separation piston 48 in the treatment fluid chamber 44 (FIG. 2). This may ensure that the pump 34 handles clean fluid. When the injection is completed, borehole fluid may be injected, via an intake 50 through most pipes and valves 52 to ensure proper clean-up and avoid hardening of treatment fluid in the pipes causing plugging. However, such a clean-up operation may be bypassed if the sealant fluid has no intrinsic ability to set.

When the treatment fluid has hardened in the injected volume behind casing 24, the tool may perform a further injectivity test. If the first injection of the treatment fluid achieved a successful repair, no further injection should be possible. The tool then may plug the hole in the casing 24, for example by inserting a plug or rivet 54 in a similar manner to the Schlumberger Cased-Hole Dynamic Tested (CHDT). Plugging may also be achieved by the installation of a short section of an expandable structure, for example a short metal pipe expanded inside the casing diameter.

If the first repair attempt fails (as indicated by a further injectivity test), the tool may re-initiate a new treatment fluid injection cycle and test. Multiple cycles may be required to achieve perfect isolation.

The tool may pump multiple fluids with minimum interaction between them. The first fluid to pump behind the casing may be for the injectivity test. It may be either fluid from the main wellbore, or it may be a specific fluid to avoid contamination of the volume to treat behind the casing 24. Such a fluid may be water, clear brine, acid, or solvent, contained in a reservoir of the tool. A particular reservoir 44 may hold the treatment fluid to inject behind the casing 24.

Inside the tool, a manifold 42 may allow the connection of the desired reservoir to the injection port 32. In FIG. 2, the fluid does not pass through the pump 34. The pump 34 may deliver fluid from the main borehole 12 to the back of a separation piston 48 of the selected reservoir. A manifold 42 connects the discharge of the pump 34 on to the reservoir.

Also, the reservoirs may be maintained at the hydrostatic pressure of the borehole. This may be achieved by applying the well pressure on top of the separation piston 48 by opening the appropriate valves 52.

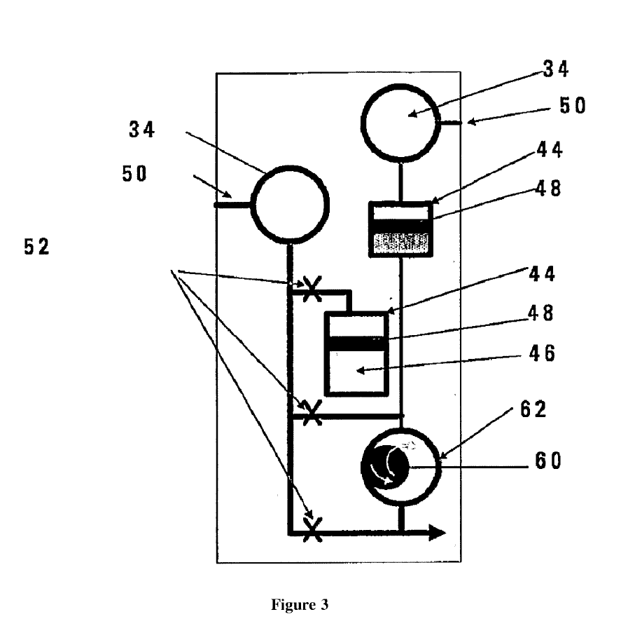

The mixing may be achieved by simply delivering two or more products via a T-intersection connected to the port 32. After the intersection, and before the exit of the injection port 32, a mixer may ensure adequate homogeneity of the fluid. In some cases a static mixer may be sufficient, but for a paste, the mixing may be performed by deforming the paste with a moving system such as eccentric rollers 60 in a cylindrical chamber 62 (FIG. 3). The roller(s) 60 may roll against the wall of the mixing chamber 62. Thus, the rollers 60 may rotate on themselves and simultaneously around the center of the mixing chamber 62.

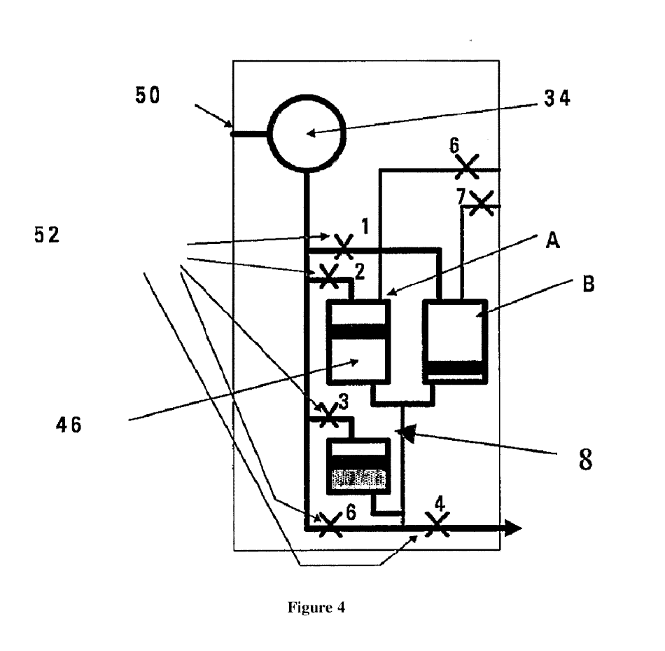

Another mixing process is based on a system of three chambers (FIG. 4). With this system, two similar reservoirs (A & B) may be used. One is filled with treatment fluid; the other one is empty (or both are half filled). The first step is to inject the chemical by pumping well fluid through valve 3. As the exhaust valves (6 and 7) of reservoir A and B are open, the chemical is placed in contact with the treatment fluid via the transfer channel 8 (all the other valves are closed during this chemical injection phase). The chemical injection may be stopped after proper dosing. Then the treatment fluid with the chemical may be transferred multiple times from reservoir A to B and back. This is achieved by activating the pump 34 through either valves 1 or 2, while the exhaust valve (6 or 7) of the other reservoir is open. The transfer action may ensure proper homogenization of the treatment fluid with the chemical. Finally, the treatment fluid may be pumped from the tool through valve 4 by simultaneously opening valves 1 and 2 (while valves 6 and 7 are closed) (the other valves also being closed). The other valves may be used for other operations such as an injection test or clean-up. The dosing of the multiple products may be achieved by the proportionality of the pumped fluid on the reverse side of the separation pistons 48, 48′ in the relevant reservoirs 44, 44′ (FIG. 3). This proportionality may be achieved using a volumetric pump such as progressive cavity pump.

The cleaning of the section filled by “ready to set” treatment fluid may be desirable. This cleaning may be desirable throughout the tool after the mixing of the setting agent, as the treatment fluid may set in a time before the tool is pulled out of the well. The cleaning may be achieved by circulating cleaning agent and solvent through the tool. These chemicals are contained within reservoirs of the tool. Final cleaning may be achieved by pumping fluid from the borehole through the tool. The fluids used to clean the machine may be rejected into the main wellbore 12.

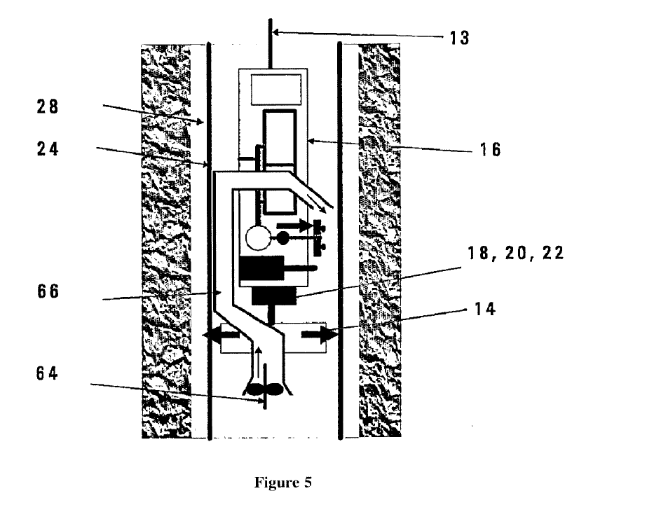

After the operation of the tool, the fluid in the borehole may be partially polluted. In particular, the cleaning fluids for the machine may be rejected in the borehole. After the injection, treatment fluid may also be present in borehole. Normally the wellbore should stay clean as the packer pad 30 guides the treatment fluid from the tool to the drilled hole in the casing 24. However in case of packer leakage or failure, some treatment fluid may be injected from the tool into the well bore. To limit the inconvenience of pollution of the well bore, the tool may be equipped with a diluting system (FIG. 5). This system comprises a diluting pump 64 extended by a long discharge tube 66. The pump 64 sucks the wellbore fluid near the packer and forces it into the tube 66 that guides the fluid far away from (and below) the tool. Fluid circulation may be established in the casing 24 outside the tube 66. The pump 64 may comprise one or more high-speed propellers that mixes the treatment fluid with the borehole fluid and ensures dilution. The diluted fluid may be circulated multiple times through the pump 64 via the tube 66. This dilution ensures that the treatment fluid cannot set in a large block within the wellbore, while cleaning fluids such as solvent or acid are also diluted. However, such a clean-up step may be bypassed if the sealant fluid has no intrinsic ability to set.

The drilled hole (for squeeze) may be plugged by the tool at the end of the job. The plugging may be achieved by a metal plug forced into the drilled hole (as with the Schlumberger Cased-Hole-Dynamic-Tester). However, the hole may have to be cleaned before the insertion of the plug, as treatment fluid may have hardened in it. The cleaning may be performed by either re-running the drill bit in the hole, or by honing or reaming the hole by a slightly larger bit.

The plugging of the hole may also be achieved by the lining the casing of the well with a thin tubular body. This tubular body may be a metal tube expanded to casing diameter. The expansion may be simplified by the use of a corrugated sleeve. The sleeve may also be a downhole cured patch of resin and fibre (such as the PATCHFLEX™ system from DRILLFLEX).

The tool may be designed to perform the injection of treatment fluid behind the tubular in multiple cycles. This may allow proper filling of the volume behind the tubular even when initially filled with highly gelled fluid. In some situations, the first injection may just replace part of the gelled fluid by treatment fluid. After the setting of the treatment fluid, additional cycles of injectivity test, treatment fluid injection and “wait for curing” period may be needed to achieve the perfect filling and isolation. Between these cycles, the machine may perform an internal clean-up of its mixing and injection system.

The tool may be designed to accomplish multiple construction or repair jobs during one single trip in the well. The multiple jobs may be at different depths. However, in some situations, the jobs may be performed at the same depth but at different azimuths. The number of jobs may limited by the amounts of fluid stored in the machine reservoirs.

In certain situations, it may be advantageous to ensure fluid circulation in the volume to treat behind the casing. For example, the filling of a channel left after a primary cement job, circulation across the length of the channel greatly improves the quality of the repair. The circulation may be established properly when an exit port is being made across the casing at the opposite extremity of the volume to treat.

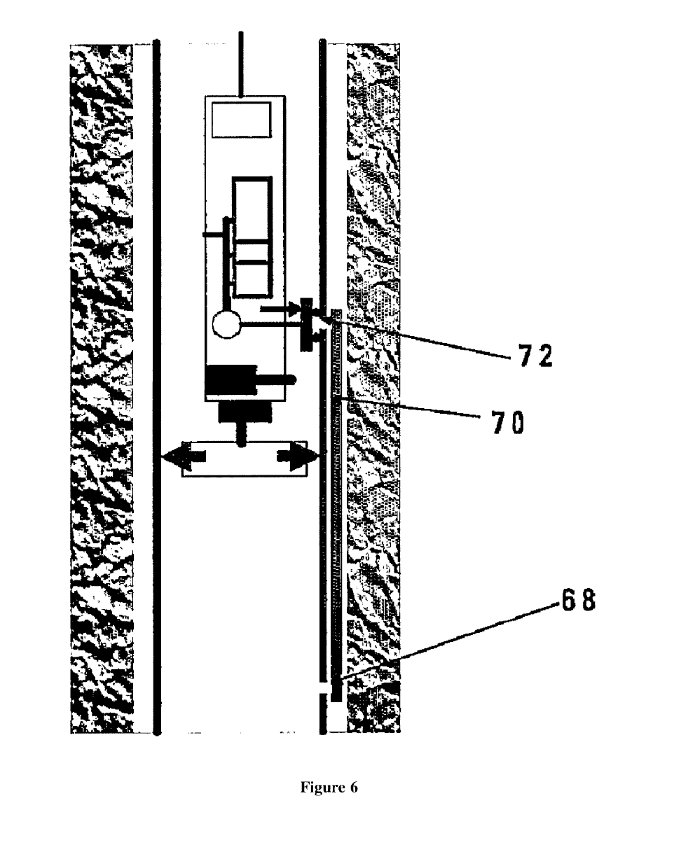

The tool may be able to drill the exit port at one extremity of the defective volume to treat, in which case a detection technique may be combined with the repair tool. In particular, depth and azimuth may be tracked during the entire process. Also, the exit port may be positioned at the lower depth to reduce the risk of the tool and cable sticking within circulated fluid. Following drilling of the exit port 68, the tool may be unclamped and moved to another depth corresponding to the other extremity of the volume to treat 70. At this new position, the tool may be clamped in place to perform the job (including drilling, circulation, treatment fluid placement and rivet installation) 72 (FIG. 6). This operation may be performed in a manner similar to the treatment without circulation; however, the circulation volume for clean-up may be larger and pumped at a higher flow rate. The proper and complete treatment may have to be performed in multiple steps (clean-up, treatment fluid placement, wait on setting, injectivity test) to achieve full filling of the cavity behind the tubular.

After plugging of the injection port 72 with a rivet, the tool may be re-positioned in front of the other hole 70 to install the plug (or rivet) in the casing 24. This means that the tool may be equipped with a proper re-positioning system. The system may include (or be associated with) an imaging tool to locate the hole (ultrasonic imaging). The tool displacement may be well-controlled to allow the machine to slide from the imaging position (to find the hole) to the working head position (to install the rivet). This accurate displacement may achieved by a tractor measuring the linear displacement. The working head 16 may be equipped with sensing device(s) such as finger(s) to sense the surface and locate the small hole. Other locating techniques are also possible. One particular technique may be to install a locating system in the casing. This system may be based on the concept of retrieval locking devices equipped with slips (as used in retrieval bridge plugs). This system may be locked into the casing at the proper depth by the tool. This locked device may be equipped with a system such that the tool may return to the same depth and the same azimuth. To find the same azimuth, the casing locating system may be equipped with a “mule shoe” device as used inside drill collar for locating fishable MWD tools. After multiple relocations of the tool, the tool may unset the casing locating device and fish it. The same device may be re-installed at an another location for other remedial tasks.

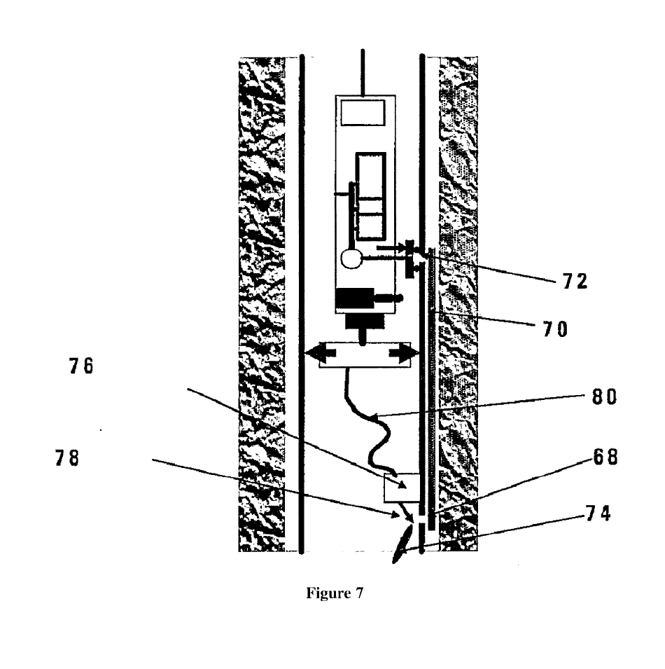

When circulation is allowed by virtue of the two (or more) holes, one may monitor the fluid 74 circulated out of the exit port 72 back into the casing 24 (FIG. 7). During the clean-up phase, this monitoring may allow detection of clean returned fluid 74, so that the clean-up may be stopped. During treatment fluid placement, it may be vital to limit the amount of treatment fluid re-entering the internal bore of the casing 24, to avoid major contamination by hardening treatment fluid inside the casing.

Monitoring may be performed by a instrumented device 76 left near the exit port 68. This device may include as sensors 78 a pH meter, flow meter, color monitoring device, etc. The device 76 may be clamped onto the casing 24. This clamping may be performed by a mechanical slip or latch system or by magnetic clamping. The monitoring device 76 may be a shuttle of the tool 10 connected via an electrical cable 80 for power and signal communication. Or, it may be an independent device equipped with a battery and use wireless communication with the main tool 10.

Channels behind casing may be filled with gelled mud that was not displaced during primary cementing. Even when the two-hole process described above is being used to ensure good circulation in the volume behind the casing, it may be difficult to displace the mud properly over the full section of the channel. In certain cases, acid may help to break the mud. Vibration may also be an efficient technique to break the gel during circulation. The flow for the circulation may be pulsed at high amplitude. These vibrations may be generated by a rotary valve limiting the flow, similar to a mud-pulse siren used for MWD telemetry.

The tool may also be used to place a ring of treatment fluid behind a solid casing. This technique maybe advantageous for placing high quality treatment fluid in specific areas where treatment fluid pollution should be minimized. An example of this situation may be the placement of a high quality isolation ring in front of the cap rock above the oil and gas reservoir. For this application, the two-hole process may be used with the holes being drilled at the same (or similar) depth but a different azimuth. The fluid injection may then be performed in circumferential flow behind the casing.

The clean-up of the annulus outside the casing may be accomplished by sufficient fluid flow, but the contact time between the cleaning fluid and the gelled mud may be limited as the volume of fluid may be limited to avoid large volume contamination in the main bore-hole by the fluid exiting the exit port. The contact time may be largely improved by the introduction of new circulation system. In one example, the process collects the returned fluid in a return tank. A second pad and packer may be set at the exit port to allow collection of the exiting fluid in a return tank. When no additional storage in the return tank is available, the additional fluid may be discharged into the main well-bore via a by-pass valve.

A example is based on the use of a magnetic fluid. For this application the cleaning fluid and/or the treatment fluid may contain magnetic particles. The treatment fluid may be placed in the annular ring by conventional pumping through one port (and returns via the other port). When the fluid is properly placed, the tool positions a rotor in the main borehole at the depth of the treatment fluid annular ring. This rotor may be equipped with high strength magnets with their poles aligned in a radial direction. The machine may sets the magnets in rotation, generating a rotating magnetic flux that may ensure some attraction onto the magnetic particles in the fluid of the annular ring, creating fluid rotation in the annulus. This fluid rotation in the annulus may stay active as long as the magnetic rotor of the tool is turning. This may allow a large contact time between the moving cleaning fluid and the gelled mud in the annulus for optimal cleaning of the annulus.

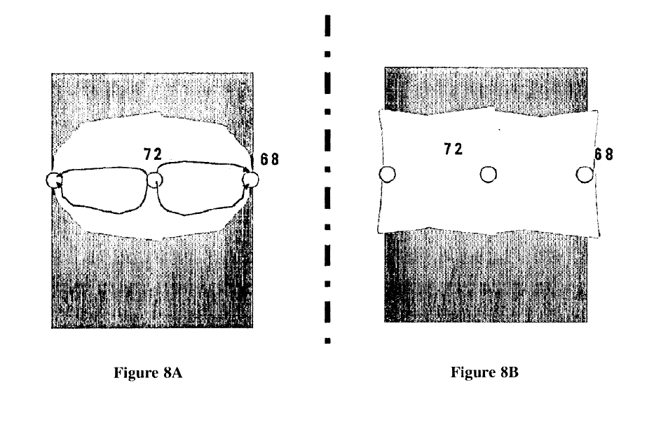

As described above, treatment fluid may be injected and circulated behind the Casing to form a sealing ring via the use of two ports (or communication holes). The treatment fluid may be injected through one of these ports while fluids from behind the casing flow into the casing by the other ports. The flowing pattern may not be uniform behind the casing, the flow line diverging around the injection port 72 and converging towards the exit port(s) 68. This means that the treatment fluid may not form a uniform ring behind the casing, it may be wider near the injection port and may have limited extension near the exit port (FIG. 8A). This limited sealing extension near one port may be a source of leakage from the bottom of the annulus towards the top part of the annulus (or reverse).

To reduce this issue, a second treatment fluid injection may be performed from the other port 68, previously the exit port (the role of the port is changed). This reversed placement allows an extension of the ring of cement near both ports 68, 72. When the treatment fluid placement is completed, the ports 68, 72 may be plugged with a metal plug as described above.

Sealant placement behind the casing may be a complex operation. The tool may monitor, and transmit to the surface in real-time, various parameters to ensure the job quality, including depth and azimuth of the drilled holes; pumping parameters for each fluids at each phase: pressure, flow rate, pumped volume, temperature; and parameters of the returned fluids near the exit port. Parameters monitored to identify the returned′ fluid may include pH and resistivity. Furthermore, flow rate may be monitored to determine the amount of fluid lost in the formation. An acoustic image of the cement sheath behind the casing before and after the treatment process may be used to determine the efficiency of the treatment. The acoustic image of the inside of the wellbore may also be used to determine the status of the casing before the job, the performance of the cleaning of the casing internal bore after the job and the proper installation of the plugs in the hole.

It will be appreciated that a number of changes can be made to the tool depending on uses while retaining the basic concept of the disclosure.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

1. A method for treating a subterranean well having a borehole wall, at least one tubular body and at least one cement sheath, comprising:
(i) positioning a tool in the well adjacent to a region to be treated;
(ii) locking the tool in place with a clamping system;
(iii) orienting the tool azimuthally with a positioning system; and
(iv) using a pumping system to pump treatment fluid from a reservoir in the tool to the region of the cement sheath to be treated;
wherein the method further comprises drilling a hole into the tubular body prior to pumping treatment fluid;
wherein the fluid is solids free or the fluid is a suspension containing solids having a particle size between 1 nm and 100 nm.

2. The method of claim 1, wherein the treatment fluid comprises a solids-free resin, the resin comprising epoxy resin or furan resin.

3. The method of claim 1 or 2, wherein the treatment fluid comprises an alkali-swellable latex.

4. The method of any one of claims 1-3, wherein the treatment fluid comprises a silica-particle suspension, the silica particles comprising colloidal silica or fumed silica or both.

5. The method of any one of claims 1-4, wherein the treatment fluid comprises a suspension comprising an alkali metal silicate an inorganic calcium-containing compound.

6. The method of any one of claims 1-5, wherein the treatment fluid comprises one or more alkali metal silicates, magnesium chloride, iron chlorides or other iron salts, aluminum chloride, alkali metal aluminates, magnesium phosphate, potassium phosphate, sodium phosphate, sodium sulfate, sodium carbonate or sodium fluoride or combinations thereof.

7. A method for restoring zonal isolation in a subterranean well having a borehole wall, at least one tubular body and at least one cement sheath, comprising:
(i) positioning a tool in the well adjacent to a region to be treated;
(ii) locking the tool in place with a clamping system;
(iii) orienting the tool azimuthally with a positioning system;
(iv) using a pumping system to pump treatment fluid from a reservoir in the tool to the region of the cement sheath to be treated; and
(v) allowing the treatment fluid to set and harden;
wherein the method further comprises drilling a hole into the tubular body prior to pumping treatment fluid;
wherein the fluid is solids free or the fluid is a suspension containing solids having a particle size between 1 nm and 100 nm.

12. The method of claim 11, wherein the treatment fluid comprises either:
a solids-free resin, the resin comprising epoxy resin or furan resin;
an alkali-swellable latex;
a silica-particle suspension, the silica particles comprising colloidal silica or fumed silica or both;
a suspension comprising an alkali metal silicate an inorganic calcium-containing compound; or
one or more alkali metal silicates, magnesium chloride, iron chlorides or other iron salts, aluminum chloride, alkali metal aluminates, magnesium phosphate, potassium phosphate, sodium sulfate, sodium carbonate, sodium phosphate or sodium fluoride or combinations thereof.

13. The method of claim 11 or 12, wherein a region of the well to be treated is a fault in a cement sheath surrounding the well, the method further comprising measuring the size, shape and type of fault prior to treatment.

14. The method of any one of claims 11-13, further comprising drilling at least two separated holes in the tubular body and circulating treatment fluid from one hole to the other.

15. The method of any one of claims 11-14, further comprising pumping a cleaning fluid through the tool after the treatment fluid has been pumped.
